(19) United States
(12) Patent Application Publication
(10) Pub. No.: US 2003/0233396 A1
(43) Pub. Date: Dec. 18, 2003

(54) Method and apparatus for real time storage of data networking bit streams

(75) Inventor: Paul Kenneth Wolfe JR., Naperville, IL (US)

Correspondence Address: FITCH EVEN TABIN AND FLANNERY, 120 SOUTH LA SALLE STREET, SUITE 1600, CHICAGO, IL, 60603-3406, US

(73) Assignee: Digital Software Corporation

(21) Appl. No.: 10/347,173

(22) Filed: Jan. 17, 2003

Related U.S. Application Data
(60) Provisional application No. 60/352,514, filed on Jan. 31, 2002.

(51) Int. Cl. G06F 15/16

(52) U.S. Cl. 709/200; 714/45

(57) ABSTRACT

A method and arrangement for providing buffering and real time storage of high-speed data stream from internetwork of Wide Area Networks (WAN), Metropolitan Area Networks (MAN), and/or Local Area Networks (LAN) is disclosed. The exemplary apparatus comprises one or more parallel bus interfaces from Complex Programmable Logic Devices (CPLD) to buffer memory. The network data stream is directed through the CPLD where data compression takes place. The compressed data is stored (buffered) in memory buffers. Each memory buffer is associated with a hard disk drive via a PCI-X bus I/O controller. When the memory buffer is filled, input from the data network is directed to another RDRAM memory buffer. The content of each filled memory buffer is written to the hard disk drive associated with that buffer.

This application claims the benefit of Provisional Application No. 60/352,514 which is hereby incorporated by reference herein.

### TECHNICAL FIELD

This invention relates to high-speed networks, and more specifically, to a method and apparatus for providing real time storage of a high-speed continuous data bit stream.

### BACKGROUND OF THE INVENTION

Network data transmission rates are increasing at a rapid rate. Such transmission rates may presently be 700 megabits/second but standards for optical networks have been established which are near 10 gigabits/second and will increase. Further, with the increased merger of telecommunication and data communication such bit rates become much more continuous.

Consider present day hard disk drive technology with a maximum write rate of 700 Megabits/second. Compare the hard disk drive's write rate to the transmission rate of an OC-48 optical data link, which is 2.8 GigaBits/second. This optical transmission rate introduces a bandwidth difference of a factor of four (4). This bandwidth factor will only widen as higher OC rates are brought into service.

Thus, a technological solution with fast algorithm execution, is required if the present art is to meet the challenge of continuous real time storage of high-speed transmission rates.

### SUMMARY OF THE INVENTION

This problem is solved and a technical advance in the art is achieved by methods and apparatus described and claimed herein. An apparatus in accordance with an embodiment receives data from a network and stores that data in one of a plurality of buffer memories. Data received from the network is sequentially written into the ones of the plurality of buffer memories at a data rate compatible with a data rate of the network. When a buffer memory stores a predetermined amount of data the data is read therefrom and stored in a bulk storage device at a location associated with the buffer memory being read. After the predetermined amount of data is written into one buffer memory newly received data from the network is stored in other buffer memories in sequence.

In the embodiments a controller directs the reading and writing of buffer memories and bulk storage device. Further, the controller compresses the data received from the network before the data is stored in the buffer memories.

In a method and apparatus according to one embodiment, a Wide Area Network (WAN), Metropolitan Area Network (MAN), or Local Area Network (LAN) server or client sends a continuous high-speed data bit stream of information to a specific node. When a bit stream is detected, at the node, a buffering device applies appropriate compression algorithms and stores the compressed information in a Virtual Memory Buffer. When the Virtual Memory Buffer is full, the contents of the Virtual Memory Buffer are written to one of a plurality of hard disk drives in a circular queuing arrangement and a second Virtual Memory Buffer takes over the task of saving the compressed information. The process is repeated until all information has been received.

Advantageously, the hard disk drive circular queuing arrangement is attached to a mirroring subsystem. The mirroring subsystem reads the information from the hard disk drive queuing arrangement in the correct sequential order and writes the data to a Network File System (NFS), CD-ROM or DVD devices, or streaming magnetic tape.

### BRIEF DESCRIPTION OF THE DRAWINGS

A more complete understanding may be obtained from a consideration of the following description in conjunction with the drawing in which:

FIG. 1 is a block diagram illustrating the principles of the dataflow of a high-speed data bit stream;

FIG. 2 is a block diagram of the components of FIG. 1 according to one embodiment;

FIG. 3 is a block diagram of the components of FIG. 1 according to another embodiment using a combination of Complex Programmable Logic Devices.

### DETAILED DESCRIPTION

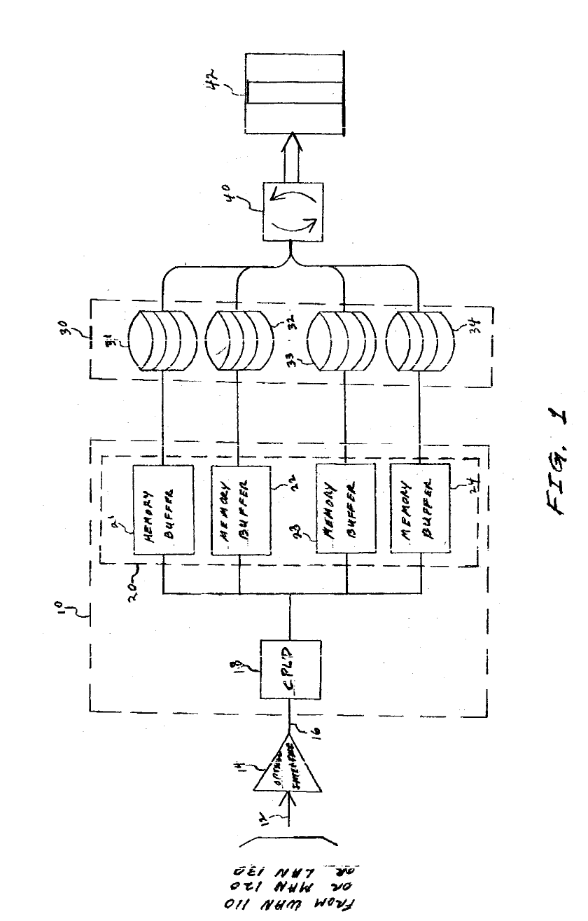

FIG. 1 shows a simplified block diagram illustrating a dataflow through the high speed buffering device 10. The high speed buffering device 10 is connected to optical interface 14 which may be an optical receiver or optical transducer as known in the art. The optical interface 14 is connected to an optical fiber 12 that provides an optical internetworking to Wide Area Networks (WAN) 110, Metropolitan Area Networks (MAN) 120, and/or Local Area Networks (LAN) 130. Although the embodiments discussed herein relate to optical networks, the principles taught thereby apply equally to digital electronic networks communicating via copper conductors such as twist-pair or coaxial cable as known to the art, or wireless connections to antenna.

Data arrives from WAN 110, MAN 120, or LAN 130 as a high-speed bit stream on an optical fiber 12, and it is converted from an optical signal to a digital (electrical) signal by the optical interface 14. The data as a digital signal is then sent by an electrical interface 16 to a Complex Programmable Logic Device (CPLD) 18, which may include Application-Specific Integrated Circuit(s) (ASIC), Field Programmable Gate Array (FPGA) device(s), or other integrated circuit that supports some form of programmable logic.

CPLD 18 performs data compression on the data and stores the compressed data in memory buffer e.g., 21, which is one of the memory buffers that comprise a dedicated plurality of memory buffers 21-24 in a Virtual Buffer 20. Advantageously, all memory buffers in Virtual Buffer 20 are the same size. The size could be a single hard disk block size (4 or 8 kilobytes), the size of a hard disk track, or the size of a hard disk cylinder however, the size of disk block has been found advantageous. CPLD 18 writes compressed data to memory buffer 21 until it is full. Then CPLD 18 begins to fill memory buffer 22 with compressed data. This storage of compressed data continues in a circular manner in Virtual Buffer 20 by filling memory buffer 22 then filling memory buffer 23 and finally filling memory buffer 24. After memory buffer 24 is filled, the CPLD 18 starts the entire sequence over again by filling memory buffer 21. This circular manner of filling the series of memory buffers in Virtual Buffer 20 continues until all data has been received from the optical network compressed and stored.

The Virtual Buffer 20 provides a temporary storage of the compressed data since it can match the speed on the data coming in from the network. For an optical network sending data at OC-48, the miss match in bandwidth is a factor of four (4). Thus, four memory buffers in the series of memory buffers are used. As the mismatch in bandwidth increases, so does the number of memory buffers in the Virtual Buffer 20 may also increase.

The compressed data in Virtual Buffer 20 is transferred to non-volatile storage such as a hard disk drive circular queue 30, which has a dedicated non-volatile store, associated with each memory buffer. Thus, when memory buffer 21 is filled, a write operation takes place to non-volatile store 31 as other compressed data is being stored else where in Virtual Buffer 20. Likewise, when memory buffer 22 is filled, its contents are written to non-volatile store 32. Similarly, memory buffer 23 is written to non-volatile store 33, and memory buffer 24 is written to non-volatile store 34. Since there are four memory buffers, four non-volatile stores are used in the circular queue 30.

In the present embodiment as shown in FIG. 1 each of the non-volatile stores is shown as a hard disk drive. Non-volatile storage is not restricted to hard disk drives but could be Personal Computer Memory Card International Association (PCMCIA) storage devices, which is described in detail at www.pcmcia.org, flash memory such as Micron SyncFlash memory, which is described in detail at www.micron.com, or Millipede storage, which is described in detail at www.3.ibm.com/chips/index.html.

Advantageously, a mirroring subsystem 40 may be connected to the hard disk drive circular queue 30. Mirroring Subsystem 40 transfers the data stored in the hard disk drive circular queue 30 to an auxiliary storage system 42. Auxiliary storage system 42 could be a Network File Server (NFS), Storage Area Network (SAN), CD-ROM/DVD drive, or streaming magnetic tape as known to the art. Also, the Mirroring Subsystem 40 operates in accordance with software which reorders the sequence of data stored in the hard disk drive circular queue 30. In use, hard disk drive 31 contains the sequence of data items 1, 5, 9, 13 . . . ; hard disk drive 32 contains the sequence of data items 2, 6, 10, 14 . . . ; hard disk drive 33 contains the sequence of data items3, 7, 11, 15 . . . ; and finally, hard disk drive 34 contains the sequence of data items 4, 8, 12, 16 . . . Mirroring Subsystem 40 stores the data items in the sequence 1, 2, 3, 4, 5, 6, 7, 8 . . . to auxiliary storage system 42.

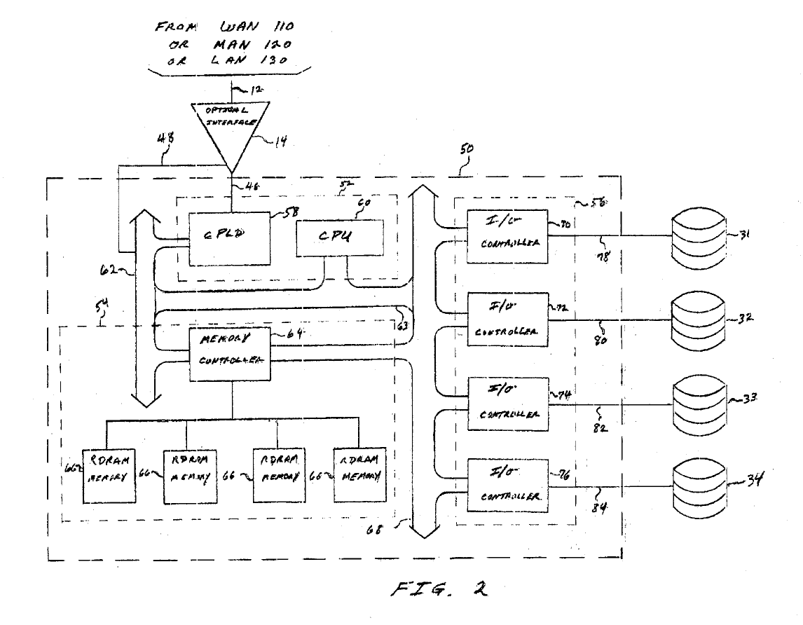

FIG. 2 is a block diagram illustrating an embodiment of the main components of the high-speed buffering device 10. High-speed buffering device 10 is, in this exemplary embodiment, a Printed Circuit Board (PCB) 50, which is divided into three major components: Programmable Control 52, to perform the necessary processing; Real-Time Storage Array 54, to buffer data arriving from the network; and Peripheral I/O Control 56, to write buffered data from Real-Time Storage Array to non-volatile storage such as a hard disk drive. The components are connected by a primary memory bus 62, a local bus 63, and secondary memory bus 68. The reason for two memory buses is to remove bus contention and latency between data arriving from the network and data that is being written to disk. By having two or more memory buses, data input/output operations are done in parallel.

Programmable Control 52 consists of a Central Processing Unit (CPU) 60, which is a processor, for example a Pentium™ processor chip, made by INTEL CORPORATION™ from Santa Clara, Calif. and is described in detail at http://www.intel.com, and a Complex Programmable Logic Device (CPLD) 58, which is programmed to do operations in parallel, for example Virtex™-II Field Programmable Gate Array (FPGA) chip, made by Xilinx®, Inc., San Jose, Calif. and is described in detail at http://www.xilinx.com/platformfpga. CPLD 58 could also be an Application-Specific Integrated Circuit (ASIC) supplied by IBM and described in detail at http://www.ibm.com. CPU 60 programmable function controls the movement of data flowing from the optical network through Real-Time Storage Array 54 to Peripheral I/O Control 56 and hard disk drives 31, 32, 33, & 34. CPU 60 directs control instructions to other components via local bus 63. CPLD 58 functions to compress data arriving from the network and stores the compressed data in Real-Time Storage Array 54. Some buffering of information may be done in CPLD 58, usually in four (4) to eight (8) kilobyte blocks. For a secure network, a decryption phase is provided before the compression phase of CPLD 58. Advantageously, the control instructions of CPU 60 can be part of the programmable instructions of CPLD 58, which may use the local bus 63 to direct control instructions to other components. In the figures the various components such as CPLD 58 and CPU 60 are shown as separate schematic blocks. It is to be understood that as implementation circuits evolve the various components may be integrated as a single device or as a device with CPU functions and part of the CPLD functions plus a separate device for a remaining portion of the CPLD functions.

Real-Time Storage Array 54 consist of a Memory Controller 64 which directs data from primary memory bus 62 to memory buffers 66 or from the memory buffers to secondary memory bus 68. Memory buffers 66 may, for example, be Rambus Dynamic Random Access Memory (RDRAM) as known to the art and described in detail at http://www.rdram.com. Alternatively, Real-Time Storage Array 54 may comprise a compact translating-head magnetic memories, two- or three-dimensional Vertical-Bloch-Line memory system, Garnet-Oxide Random Access Memory (GO-RAM), high-speed, non-volatile Random Access Memory (RAM) with magnetic storage and Hall effect sensor, flash memory, Millipede storage, ultra-high-density, non-volatile optical/optoelectronic memory, or some other form of high-speed, high-density, read/writable memory. Memory buffers are dynamically allocated from RDRAM 66 as part of the programmable function of CPU 60 and are the same size, either a single hard disk block size (4 or 8 kilobytes), the size of a hard disk track, or the size of a hard disk cylinder.

Peripheral I/O Control 56 consists of a series of I/O Controllers 70, 72, 74, & 76 which are Host to PCI-X Bridges, which ate described in detail at http://www.pcisig.com. I/O Controller 70 connects secondary bus 68 to hard disk 31 by PCI-X bus 78, which operation is described in detail at http://www.pcisig.com. I/O Controller 72 connects secondary bus 68 to hard disk 32 by PCI-X bus 80. Likewise, I/O Controller 74 connects secondary bus 68 to hard disk 33 by PCI-X bus 82, and I/O Controller 76 connects secondary bus 68 to hard disk 34 by PCI-X bus 84.

Advantageously, Peripheral I/O Control 56 may be implemented as a single Host to PCI-Express Bridge, which is the Third Generation standards of PCI and is described in detail at http://www.pcisig.com. The PCI-Express standard permits a single Host to PCI-Express Bridge to communicate with a set of peripheral devices such as hard disk drives, streaming tape drives, CD-ROM devices or other readable and/or writable electronic devices in parallel (at the same time) using different bandwidth digital signals for communications. Alternatives to PCI/PCI-X/PCI-Express interfaces are InfiniBand interface supplied by IBM and is described in detail at http://www.inifinbandta.com or GigaBridge™ PCI Switch Fabric Controller (GBP) supplied by PLX Technologies, Sunnyvale, Calif. and is described in detail at http://www.plxtech.com as well as other circuit arrangements.

Optical Interface 14 (FIG. 2) provides the physical connection to the WAN 110, MAN 120, or LAN 130 and performs the necessary optical to electrical conversion of the high-speed bit stream from an optical signal to a digital (electrical) signal. The digital signal is sent to CPLD 58 by a direct interface connection 46. An interface 48 may be used to send the digital signal from the Optical Interface 14 to CPLD 58 by means of the primary bus 62 as an alternative to connection 46. CPLD 58 processes the digital signal by performing data compression and forwards the processed data to a buffer in the Real-Time Storage Array 54 by using primary bus 62. When a buffer 66 of Real-time Storage Array 54 is full, the data therefrom is transferred to the appropriate hard disk drive e.g., 31 through the Peripheral I/O Control 56 by using the secondary bus 68, which is also a RAMBUS. If contention for the secondary bus 68 a secondary bus could be added when bus contention is a concern.

Advantageously, to prevent contention for secondary bus 68, Peripheral I/O Control 56 may be construed using dual PCI-X bus technology instead of single PCI-X bus technology. Dual PCI-X bus technology handles 64 bit wide streams of data compared to the 32 bit wide streams of data handed by single PCI-X bus technology. Both single and dual PCI-X bus technology are described in detail at http://www.pcisig.com.

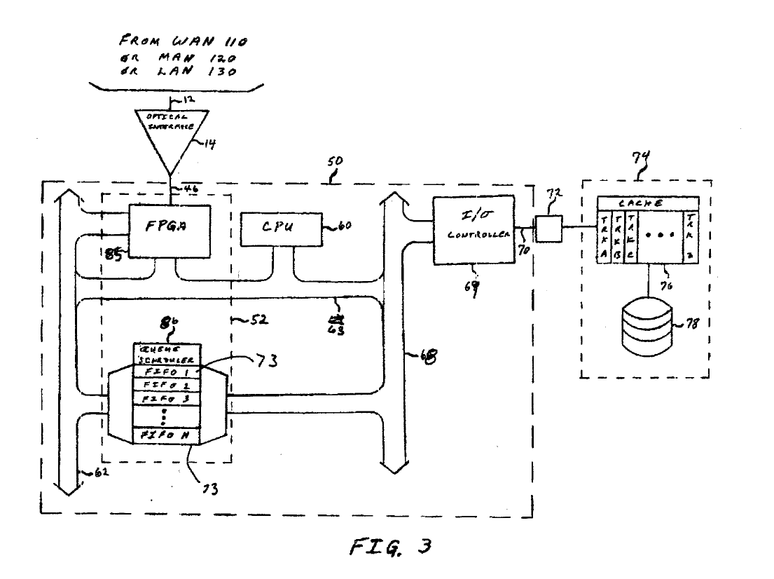

FIG. 3 is a block diagram illustrating the main components of an embodiment of the high-speed buffering device 10. High-speed buffering device 10 is, in this embodiment, a Printed Circuit Board (PCB) 50, which is divided into three major components: Programmable Logic Devices 52, to perform the necessary processing and buffering of data arriving from optical network; I/q Controller 69, to write buffered data from Programmable Logic Devices 52 into Peripheral Storage Array 74, and CPU 60 to control the entire operation of data flowing from the optical network through: Programmable Logic Devices 54 to I/o Controller 69. A primary memory bus 62, a local bus 63, and secondary memory bus 68 connect the components. CPU 60 directs control instructions to other components via local bus 63. The reason for two memory buses is to remove bus contention and latency between data arriving from the optical network and data being written to Peripheral Storage Array 74. When two or more memory buses are used data input/output operations can be done in parallel.

Programmable Logic Devices 52 consist of two Complex Programmable Logic Devices, Field Programmable Gate Array (FPGA) 85 and Priority Queue Scheduler (PQS) 86. FPGA 85 Programmable function is to compress data arriving from the optical network, for example Virtex™-II Field Programmable Gate Array (FPGA) chip, made by Xilinx®, Inc., San Jose, Calif. and is described in detail at http://www.xilinx.com/platformfpga. For a secure network, a decryption phase can be provided before the compression phase of the programmable function of FPGA 85. Real-Time Storage of compressed data from FPGA is provided by PQS 86 by using a series of First-In-First-Out (FIFO) queues, as known to the art, for example MUPA64k16 Alto™ chip, made by Music Semiconductors, Inc. Milpitas, Calif. and is described in detail at http://www.musicsemi.com. Each queue, which is the size of a hard disk drive, as known to the art buffers data until the queue is filled, then data begins to be buffered in the next queue. Data from the filled queue is transferred to the I/O Controller 69 by using secondary memory bus 68.

Continuing with FIG. 3, Optical Interface 14 provides the physical connection using optical fiber 12 to the WAN 110, MAN 120, or LAN 130 and performs the necessary Optical to Electrical (O/E) conversion of the high-speed bit stream from an optical signal to a digital (electrical) signal. The digital signal is sent to Programmable Logic Devices 52 by an interface connection 46. Programmable Logic Devices 52 does any necessary processing of the digital signal like data compression and performs Real-Time Storage of data to a buffer in FIFO queues 73 by using primary bus 62, which is a RAMBUS. When queue is full, the data is transferred to the Peripheral Storage Array 74 through the I/o Control 69, which is a host to PCI-X Bridge by using the secondary bus 66. Data is transferred from the I/O Control 56 to Peripheral Storage Array 74 through the use of a PCI-X bus 70 and Fibre Channel Interface 72, which is described in detail at http://www.fibrechannel.com.

Advantageously, Peripheral Storage Array 74 may be a high performance Redundant Array of Independent Disks (RAID) system like the CLARiiON FC4500 System provided by EMC Corporation, Hopkinton, Mass. and is fully described at http://www.emc.com. Such a system uses arrays of hard disk drives 78 coupled with high-speed cache Static Dynamic Random Access Memory (SDRAM) 76 as known to the art, which provides high-speed real-time access to data. Such cache memory can provide access to a maximum of 30,000 I/O operations. Alternatively, Peripheral Storage Array 74 may comprise ultra-high-density non-volatile optical/optoelectronic memory, three-dimensional recording medium using a dynamic holographic device, multi-layer optical disks, large holographic memory, or some other form of high-density, read/writable, non-volatile peripheral storage.

We claim:

1. An arrangement for receiving digital data from a high speed network, comprising:
a plurality of high speed buffer memories;
an incoming data unit connected to receive data from a high speed network and for writing received data into the high speed buffer memories, the incoming data unit being operative to write a predetermined amount of data in each of the plurality of high speed buffer memories in a predetermined sequence;
a plurality of bulk storage devices, each associated with one of the high speed buffer memories; and
first data reading apparatus for reading data from each of the buffer memories and writing the data so read into the bulk storage device associated therewith, the data being read from a given buffer memory at times that the given buffer memory is not being written into by the incoming data unit.

2. An arrangement according to claim 1 comprising
an auxiliary storage system and auxiliary storage control for reading data from the plurality of bulk storage devices and writing the data so read into the auxiliary storage system.

3. An arrangement according to claim 2 wherein the auxiliary storage control is operative to write data into the auxiliary storage system in the order that the data was received from the network.

4. An arrangement according to claim 1 where the incoming data unit compresses received data before writing that data into the high speed buffer memories.

5. An arrangement according to claim 4 wherein the digital data conveyed by the high speed network is encrypted and the incoming data unit decrypts the received data before the received data is compressed.

6. An arrangement in accordance with claim 1 wherein each of the high speed buffer memories is of predetermined storage capacity.

7. An arrangement according to claim 6 wherein the incoming data unit writes data into each high speed buffer memory until the storage capacity of the high speed buffer memory being written, is filled.

8. An arrangement according to claim 1 wherein the incoming data unit comprises a first memory bus for receiving data from the network a second memory bus for conveying data to the bulk storage devices and a memory controller for receiving from the first memory bus data to be written into the high speed buffer memories and for transmitting on the second memory bus, data to be stored in the bulk storage devices.

9. An arrangement according to claim 8 comprising a plurality of input/output controllers connected to the second memory bus, each of the input/output controllers being associated with one of the plurality of bulk storage devices.

10. An arrangement according to claim 1 wherein the incoming data unit comprises a complex programmable logic device for receiving data from the network.

11. An arrangement according to claim 10 wherein the incoming data unit comprises a central processing unit for directing the flow of data into and out of the high speed buffer memories.

12. An arrangement according to claim 11 wherein the central processing unit directs the flow of data into the plurality of bulk storage devices.

13. An arrangement according to claim 11 wherein the high speed data buffers comprise separate allocated memory buffers of a common memory structure.

14. An arrangement according to claim 1 wherein the high speed network is an optical network and the incoming data unit converts received optical data to electrical representations of the received data.

15. An arrangement according to claim 1 wherein the plurality of high speed buffer memories comprise a plurality of FIFO queues controlled by a queue scheduler.

16. An arrangement according to claim 1 wherein the plurality of bulk storage devices comprises a high speed data cache and a redundant array of independent disks.

17. An arrangement according to claim 1 wherein the plurality of bulk storage device comprises a plurality of nonvolatile stores.

18. An arrangement according to claim 17 wherein the nonvolatile stores comprise hard disk drives.
